(19) United States
(12) Patent Application Publication
(10) Pub. No.: US 2025/0390974 A1
(43) Pub. Date: Dec. 25, 2025

(54) GPU-accelerated scheduling system and scheduling method of GPU-accelerated scheduling system

(71) Applicant: CHUNGBUK NATIONAL UNIVERSITY INDUSTRY-ACADEMIC COOPERATION FOUNDATION, Cheongju-si (KR)

(72) Inventors: Jihyeon CHOI, Cheongju-si (KR); Sangho SONG, Cheongju-si (KR); Hyeonbyeong LEE, Cheongju-si (KR); Dojin CHOI, Changwon-si (KR); Jongtae LIM, Cheongju-si (KR); Jaesoo YOO, Cheongju-si (KR)

(73) Assignee: CHUNGBUK NATIONAL UNIVERSITY INDUSTRY-ACADEMIC COOPERATION FOUNDATION, Cheongju-si (KR)

(21) Appl. No.: 19/063,064

(22) Filed: Feb. 25, 2025

(30) Foreign Application Priority Data
Jun. 25, 2024 (KR) 10-2024-0082476

(51) Int. Cl. G06T 1/20

(52) U.S. Cl. CPC G06T 1/20

(57) ABSTRACT

Provided are a GPU-accelerated scheduling system and a scheduling method of the GPU-accelerated scheduling system. The GPU-accelerated scheduling system that determines a loading order of each partition included in a dynamic graph transferred to a GPU includes a CPU including a graph preprocessing module partitioning an input dynamic graph into a plurality of partitions and a scheduling module providing a loading order for the partitioned partitions based on a priority of a predetermined criterion, wherein the CPU determines the priority based on at least one of whether the partitions are updated, whether the partitions are common, active vertices, and potential active vertices.

### TECHNICAL FIELD

The following disclosure relates to a GPU-accelerated scheduling system and a scheduling method of the GPU-accelerated scheduling system.

### BACKGROUND

In the era of big data, graphs have been widely used to effectively express real-world data, such as social networks, road networks, and web networks. Meanwhile, graphs may visually express complex relationships and structures between objects through vertices and edges, and such graph data are large in scale and have complex structures. In addition, graphs may be static or dynamic, and while static graphs do not change over time, dynamic graphs continuously change in shape as vertices or edges are added or removed over time. Actual graph data is generally large in scale and dynamic. For example, on Facebook, an average of 6 accounts are registered per second, and on the World-Wide Web, about 3 new accounts are created per second. In addition, X users create about 10,000 posts per second, and on the Alibaba e-commerce platform, 20,000 or more transactions occur per second.

Recently, research has been actively conducted to efficiently process large-scale graph data, but dynamic graphs are much more complex to process than static graphs. Unlike vertex graphs that have a single point in time, dynamic graphs have to track and manage changes over time. Since dynamic graphs are often updated in real time or almost real time, rapid processing is required. Tracking and analyzing the state of such dynamic graphs in real time may be a difficult task in terms of computing resources and time. In order to process dynamic graphs that change rapidly within a short period of time, a traditional approach based on the existing central processing unit (CPU) was first designed. CPUs have been designed as general-purpose processing devices and may perform various types of calculations. Recently, various mechanisms have been designed to effectively reduce unnecessary calculations of dynamic graphs. However, CPUs have limitations in achieving high performance for large-scale graph processing due to limitations in parallelism.

Accordingly, various studies have been conducted recently using the parallel processing capabilities of graphics processing units (GPUS). GPUs support thousands of concurrent threads, which are very efficient in parallel processing operations. These characteristics of GPUs enable quick processing of complex calculations of large-scale graph data. In addition, it enables real-time analysis of changing graph structure data. cuSTINGER, Hornet, GPMA, LPMA, aimGraph, and faimGraph are GPU-based dynamic graph update systems for graphs that change over time. cuSTINGER and Hornet are array-based space management systems, and GPMA and LPMA are space management systems based on compressed sparse rows (CSR). aimGraph and faimGraph are systems that utilize chain-based space management. Among them, cuSTINGER and GPMA are representative studies that migrated GPU-based systems, STINGER and PMA, to the GPU platform. This migration includes optimizations for the computation and memory access functions of GPUS.

Most traditional systems are based on the assumption that input graph may be stored entirely in GPU memories. In other words, the input graph is limited to the limited global memory size of GPUs. To solve this limitation, out-of-memory graph processing systems were designed. EGraph was designed to integrate Subway, a GPU-based static graph processing system, and dynamic graph update method of GPMA and process graphs that exceed GPU memory. Despite utilizing the fast parallel processing capability of the GPU, processing a rapidly changing dynamic graph is very complicated because fast data processing is required to reflect changes in the graph in real time considering the limited memory.

### RELATED ART DOCUMENT

### Patent Document

Korean Application Publication No. 10-2023-0157081 (“Method and system for determining progressive connected elements in dynamic graph”, published on Nov. 16, 2023)

### SUMMARY

An exemplary embodiment of the present invention is directed to providing a GPU-accelerated scheduling system including a scheduling technique for efficiently processing a dynamic graph and a computation reduction technique for reducing the amount of computation to be calculated in a GPU for a limited memory environment of the GPU.

In one general aspect, a GPU-accelerated scheduling system includes: a CPU including a graph preprocessing module partitioning an input dynamic graph into a plurality of partitions and a scheduling module providing a loading order for the partitioned partitions based on a priority of a predetermined criterion, wherein the CPU determines the priority based on at least one of whether the partitions are updated, whether the partitions are common, active vertices, and potential active vertices.

The scheduling module may determine the priority based on an equation below:

$$Val ( {P}_{i} ) = N ( {P}_{i} ) + α \frac{{\sum }_{S , INS} Active ( {P}_{i} )}{\vert S \vert} + β \frac{{\sum }_{S , INS} Potential ( {P}_{i} )}{\vert S \vert} + K$$

where (N(Pᵢ) is a number of snapshots to process Pᵢ when an update occurs, Active(Pᵢ) is a number of active vertices in a partition, Potential(Pᵢ) is a number of potential active vertices in a partition, K indicates whether a partition is updated, and α and β are scaling factors.

The graph preprocessing module may partition the dynamic graph so that a size of the partitions does not exceed a memory size of the GPU.

The graph preprocessing module may use a vertex-cut method.

The GPU-accelerated scheduling system may further include: a partition transfer module transferring the plurality of partitions to the GPU based on the determined loading order.

The CPU may further include a computation reduction module eliminating unnecessary computations based on a result of a snapshot of the dynamic graph over time before transmitting the partition to the GPU.

When a specific vertex or edge is inserted or deleted in the snapshot result over time, if the snapshot result at a given time is the same as the snapshot result at a preceding time, the computation reduction module may omit computations between these two points in time.

In another general aspect, a scheduling method of a GPU-accelerated scheduling system includes: (a) partitioning, by a CPU, an input dynamic graph into a plurality of partitions; and (b) determining a loading order of the partitioned partitions based on a priority of a predetermined criterion, wherein, in (b), the priority is determined based on at least one of whether the partitions are updated, whether the partitions are common, active vertices, and potential active vertices.

In (b), the priority may be determined based on an equation below:

$$Val ( {P}_{i} ) = N ( {P}_{i} ) + α \frac{{\sum }_{S , INS} Active ( {P}_{i} )}{\vert S \vert} + β \frac{{\sum }_{S , INS} Potential ( {P}_{i} )}{\vert S \vert} + K$$

where (N(Pᵢ) is a number of snapshots to process Pᵢ when an update occurs, Active(Pᵢ) is a number of active vertices in a partition, Potential(Pᵢ) is a number of potential active vertices in a partition, K indicates whether a partition is updated, and α and β are scaling factors.

In (a), the dynamic graph may be partitioned so that a size of the partitions does not exceed a memory size of the GPU.

In (a), a vertex-cut method may be used.

The scheduling method may further include: (c) transmitting the plurality of partitions to the GPU based on the determined loading order.

The scheduling method may further include: before (c) and after (b), eliminating unnecessary computations based on a result of a snapshot of the dynamic graph over time before transmitting the partition to the GPU.

When insertion and deletion of a specific vertex or edge occurs in the result of the snapshot over time and a result of the snapshot at a specific point in time is the same as a result of a snapshot at a previous point in time before the specific point in time, a computation between the specific point in time and the previous point in time may be omitted.

Other features and aspects will be apparent from the following detailed description, the drawings, and the claims.

### BRIEF DESCRIPTION OF THE DRAWINGS

FIG. 1 is a schematic diagram illustrating a graph processing process including a GPU-accelerated scheduling system according to an exemplary embodiment of the present invention.

FIG. 2 is a schematic diagram illustrating a scheduling method according to an exemplary embodiment of the present invention.

FIG. 3 is a schematic diagram illustrating an active vertex and a potential active vertex in a dynamic graph according to an exemplary embodiment of the present invention.

FIG. 4 is a schematic diagram illustrating a vertex activated due to a deleted edge in FIG. 3.

FIG. 5 is a schematic diagram illustrating a case in which a potential active vertex becomes an active vertex after FIG. 4.

FIG. 6 is a schematic diagram illustrating an exemplary embodiment in which computation reduction occurs for the same edge.

FIG. 7 is a flowchart illustrating a scheduling method of a GPU-accelerated scheduling system according to an exemplary embodiment of the present invention.

### DETAILED DESCRIPTION OF EXEMPLARY EMBODIMENTS

In order to describe the present invention, the operational advantages of the present invention, and the objects achieved by the practice of the present invention, exemplary embodiments of the present invention are described.

Terms used in the present application are used only to describe specific exemplary embodiments, and are not intended to limit the present invention. A singular form may include a plural form if there is no clearly opposite meaning in the context. It will be further understood that the terms “comprises” or “have” used in this specification specify the presence of stated features, numerals, components, parts, or a combination thereof, but do not preclude the presence or addition of one or more other features, numerals, components, parts, or a combination thereof.

In describing the present invention, if it is determined that a detailed description of a related known configuration or function may obscure the gist of the present invention, the detailed description will be omitted.

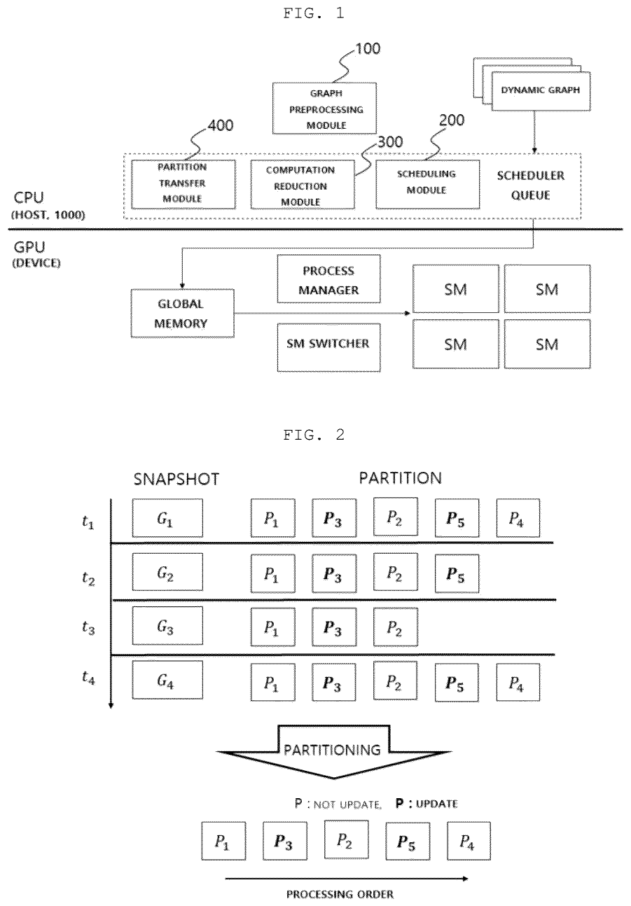

FIG. 1 is a schematic diagram illustrating a graph processing process including a GPU-accelerated scheduling system according to an exemplary embodiment of the present invention.

As illustrated in FIG. 1, a GPU-accelerated scheduling system 1000 according to an exemplary embodiment of the present invention may include a central processing unit (CPU) 1000.

Here, the CPU 1000 may communicate with a graphics processing unit (GPU) and transmit a dynamic graph to the GPU, and the GPU may quickly parallel-process the received dynamic graph, thereby further accelerating a processing speed. Here, the GPU-accelerated scheduling system 1000 may perform preprocessing, management, and scheduling of the graph using the CPU 1000 to maximize the use of the parallelism of the GPU and further accelerate the graph processing task of the GPU.

The CPU 1000 may include a graph preprocessing module 100 and a scheduling module 200.

The graph preprocessing module 100 may receive a dynamic graph, and first, the graph preprocessing module 100 may perform the role of partitioning the input dynamic graph into a plurality of partitions. Here, when partitioning the dynamic graph into partitions, the graph preprocessing module 100 may preferably use a vertex-cut method, thereby partitioning the dynamic graph into a size that fits a limited GPU memory. The vertex-cut method refers to partitioning the vertices of a graph into several parts and is a method of optimizing the size of the partitions according to a memory size of the GPU. This method allows efficient use of memory while maintaining the structure of the graph. The size of the partitioned partition may be expressed by the following formula.

$$\vert Partition \vert \leq \frac{\vert Global \vert}{N}$$

Each of the partitioned partitions may be allocated to an SM of the GPU and processed in parallel. If an update occurs in the graph later through a graph division process (for example, insertion or deletion of an edge/vertex), only a partition related to the graph update may be processed. Accordingly, data transmission cost between the CPU and the GPU may be reduced, and only data necessary for the graph update may be efficiently transmitted to the GPU to minimize transmission of duplicated data.

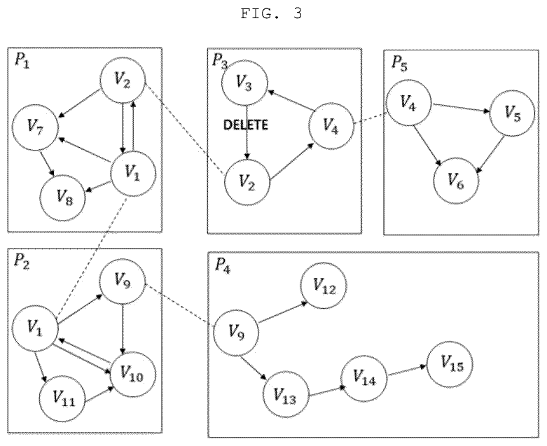

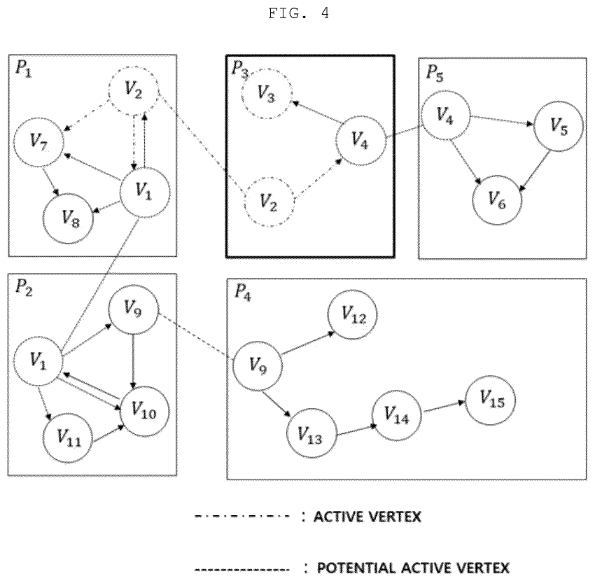

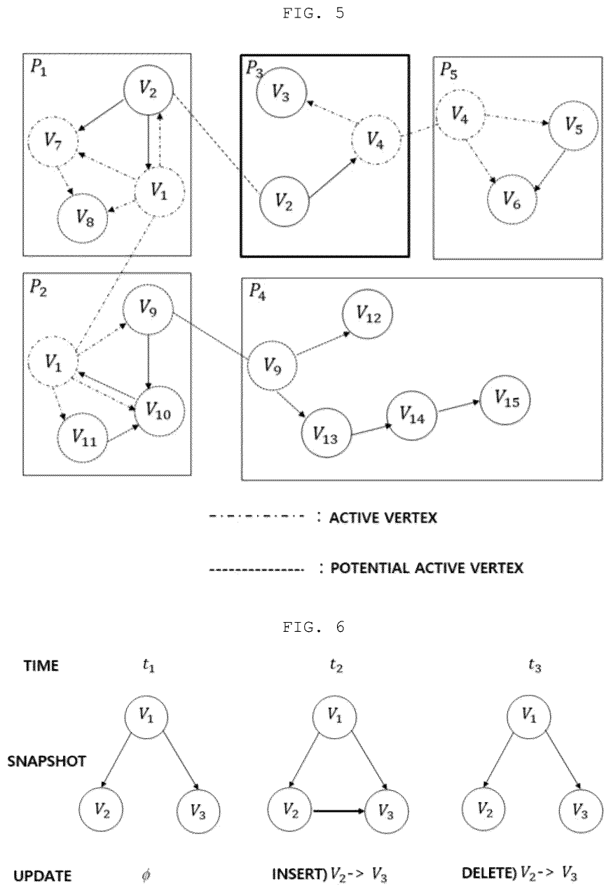

FIG. 2 is a schematic diagram illustrating a scheduling method according to an exemplary embodiment of the present invention, FIG. 3 is a schematic diagram illustrating an active vertex and a potential active vertex in a dynamic graph according to an exemplary embodiment of the present invention, FIG. 4 is a schematic diagram illustrating a vertex activated due to a deleted edge in FIG. 3, and FIG. 5 is a schematic diagram illustrating a case in which the potential active vertex becomes an active vertex after FIG. 4.

As illustrated in FIG. 2, in the GPU-accelerated scheduling system 1000 according to an exemplary embodiment of the present invention, before transmitting the partitions partitioned through the graph preprocessing module 100 to the GPU, the scheduling module 200 may efficiently plan and coordinate computations for each partitioned partition.

Specifically, the scheduling module 200 may determine priorities for the partitioned partitions based on a predetermined criterion and determine a loading order regarding which partition to load to the GPU first.

More specifically, referring to the process of partitioning the input dynamic graph into partitions and scheduling, as illustrated in FIG. 2, snapshots G_1 to G_4 may be generated over time from t1 to t4. Here, the graph preprocessing module 100 may perform a process of partitioning a snapshot exceeding the size of the GPU memory into a plurality of partitions. Thereafter, the partitions of the corresponding snapshot may be loaded into a scheduler queue according to the priority that may be efficiently processed by the GPU. Here, when assigning priorities respectively to the plurality of partitions, an updated partition should be processed first. In addition, a partition commonly included in many snapshots should also be loaded into the memory of the GPU first. In addition, it is preferred to consider an active vertex and, in addition, a potential active vertex that may potentially become an active vertex in the priority. Based on this, the priority equation

$$Val ( {P}_{i} ) = N ( {P}_{i} ) + α \frac{{\sum }_{S , INS} Active ( {P}_{i} )}{\vert S \vert} + β \frac{{\sum }_{S , INS} Potential ( {P}_{i} )}{\vert S \vert} + K$$

may be as follows.

Here, (N(Pᵢ) is a number of snapshots to process Pᵢ when an update occurs, Active(Pᵢ) is a number of active vertices in a partition, Potential(Pᵢ) is the number of potential active vertices that may potentially become active vertices in a partition, K is a value that varies depending on whether the partition is updated. For example, K may be given as 1 for a partition which is updated, and K may be given as 0 for a partition which is not updated. α and β refer to scaling factors set during preprocessing to increase the influence of the N(Pᵢ) and K values, respectively, which preferably satisfy the following conditions.

$$\begin{matrix}0 \leq α < \frac{\vert S \vert}{{\sum }_{S , INS} {Active}_{max}} \\ 0 \leq β < \frac{\vert S \vert}{{\sum }_{S , INS} {Potential}_{max}}\end{matrix}$$

Meanwhile, FIG. 3 illustrates a situation in which an edge between V_2 and V_3 in partition P_3 is deleted. FIG. 4 illustrates that, when the edge between V_2 and V_3 of P_3 is deleted, V_2 and V_3 become active vertices. Also, the potential active vertices that are connected to the active vertices and may potentially become active vertices are marked in blue. V_1, V_3, and V_7 are the potential active vertices in the FIG. 4. FIG. 5 illustrates a case in which the active vertices in FIG. 4 are processed and the potential active vertices become active vertices. The potential active vertices V_1, V_3, and V_7 in FIG. 4 are processed as active vertices in FIG. 5.

In addition, based on the priority equation based on the aforementioned criteria, the CPU 1000 may load a plurality of partitions more efficiently when loading them onto the GPU.

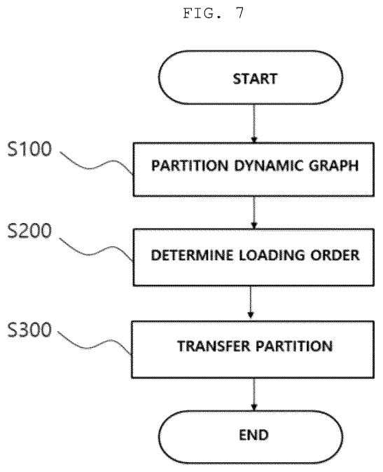

FIG. 6 is a schematic diagram illustrating an exemplary embodiment in which computational reduction occurs for the same edge.

The GPU-accelerated scheduling system 1000 according to the present invention may further include a computation reduction module 300.

The computation reduction module 300 is a module that manages a technique for reducing the amount of computation before sending a snapshot of a graph to the GPU.

Specifically, the computation reduction module 300 may operate by considering the characteristics of a snapshot when a dynamic graph changes over time. More specifically, as illustrated in FIG. 6, when a snapshot of a dynamic graph is taken over time, graphs of points in time over time may be obtained. When each time is t_1 to t_3, if an edge connecting V_2 and V_3 is inserted at time t_2 and the edge connecting V_2 and V_3 is deleted at time t_3, the snapshot of time t_1 and the snapshot of time t_3 become the same. Considering this situation, additional update computation may be avoided and the amount of computation in the GPU may be reduced thereafter.

Referring back to FIG. 1, as shown in FIG. 1, the GPU-accelerated scheduling system 1000 according to the present invention may further include a partition transfer module 400.

Based on the process described above, each partition is optimized for parallel processing on the GPU and is transferred through the partition transfer module 400 according to the loading order determined by the scheduling module 200. The transferred partitions arrive at a global memory of the GPU. The process manager of the GPU supports the partitions loaded into the global memory of the GPU through the scheduling module 200 to be efficiently and simultaneously processed in the SM. The SM is a core function of the GPU and is a unit that performs parallel processing. The process manager coordinates tasks within the SM and manages each SM to be utilized as effectively as possible. When processing partitions, computational loads of different tasks may be biased. Therefore, separate processing for loading balancing is required. An SM switcher guarantees loading balancing and performs a task of distributing tasks evenly between SMs. The SM switcher monitors a workload of each SM and reassigns unprocessed computation from SMs with high workloads to idle SMs. To this end, the tasks assigned to an SM with high workloads are temporarily stopped and the unprocessed portions are equally partitioned into subsets. Thereafter, the unprocessed portions may be taken from idle SMs to support processing of SMs with high workloads. This ensures a load balance between SMS.

FIG. 7 is a flowchart illustrating a scheduling method of a GPU-accelerated scheduling system according to an exemplary embodiment of the present invention.

As illustrated in FIG. 7, the scheduling method of a GPU-accelerated scheduling system including a CPU according to an exemplary embodiment of the present invention may partition a dynamic graph input into a plurality of partitions in operation S100, and determine a loading order of the partitioned partitions based on a priority of a predetermined criterion in operation S200.

Referring to each operation in detail, the CPU may receive the dynamic graph in operation S100, and first, the CPU may perform the role of partitioning the input dynamic graph into a plurality of sub-divided partitions. When partitioning into partitions, it is preferred to use a vertex-cut method, which allows the partitions to be partitioned into a size that fits the limited GPU memory. The vertex-cut method refers to partitioning the vertices of the graph into several parts and is a method that optimizes the size of the partitions according to the memory size of the GPU. This method allows the memory to be used efficiently while maintaining the structure of the graph. The size of

$$\vert Partition \vert \leq \frac{\vert Global \vert}{N}$$

the partitioned partitions may be expressed by an equation below.

Thereafter, in operation S200, the priority is determined based on a predetermined criterion for the partitioned partitions, and a loading order to load which partition to the GPU first may be determined accordingly.

More specifically, when assigning priorities respectively to the plurality of partitions, an updated partition should be processed first. In addition, a partition commonly included in many snapshots should also be loaded first into the GPU memory. In addition, it is preferred to consider an active vertex and also to consider a potential active vertex in the priority. Based on this, the priority equation may be as follows.

$$Val ( {P}_{i} ) = N ( {P}_{i} ) + α \frac{{\sum }_{S , INS} Active ( {P}_{i} )}{\vert S \vert} + β \frac{{\sum }_{S , INS} Potential ( {P}_{i} )}{\vert S \vert} + K$$

Here, (N(Pᵢ) is a number of snapshots to process when an update occurs, Active(Pᵢ) is a number of active vertices in a partition, Potential(Pᵢ) is a number of potential active vertices in a partition, K is a value that varies depending on whether the partition is updated. For example, K may be given as 1 for a partition which is updated, and K may be given as 0 for a partition which is not updated. α and β refer to scaling factors set during preprocessing to increase the influence of the N(Pᵢ) and K values, respectively, which preferably satisfy the following conditions.

$$\begin{matrix}0 \leq α < \frac{\vert S \vert}{{\sum }_{S , INS} {Active}_{max}} \\ 0 \leq β < \frac{\vert S \vert}{{\sum }_{S , INS} {Potential}_{max}}\end{matrix}$$

After the operation S200, a plurality of partitions may be transferred to the GPU based on the determined loading order in operation S300.

In addition, after operation S200 and before operation S300, an operation in which the CPU eliminates unnecessary computation based on the results of snapshots of the dynamic graph over time before transmitting the partition to the GPU may be further included.

Here, when the dynamic graph changes over time, an operation may be performed by considering the characteristics of the snapshot. Specifically, when insertion and deletion of a specific vertex or edge occurs in the results of snapshots over time, if the result of the snapshot at a specific point in time is the same as the result of the snapshot at a previous point in time, a process of omitting the computation between the specific point in time and the previous point in time may be included.

According to the GPU-accelerated scheduling system and the scheduling method of the GPU-accelerated scheduling system of the various exemplary embodiments of the present invention as described above, the amount of transmission between the CPU and the GPU may be reduced through a scheduling technique that may efficiently process a dynamic graph on the GPU with limited memory.

In addition, when a change in the dynamic graph is recognized and an offset computation occurs, the amount of computations may be reduced, thereby avoiding unnecessary computation.

Although the preferred exemplary embodiments of the present invention have been described above, the exemplary embodiments disclosed in the present invention are not intended to limit the technical spirit of the present invention, but are only for explanation. Therefore, the technical spirit of the present invention includes not only each disclosed exemplary embodiment, but also a combination of the disclosed exemplary embodiments, and furthermore, the scope of the technical spirit of the present invention is not limited by these exemplary embodiments. In addition, those skilled in the art to which the present invention pertains may make many changes and modifications to the present invention without departing from the spirit and scope of the appended claims, and all such appropriate changes and modifications, as equivalents, are to be regarded as falling within the scope of the present invention.

### DETAILED DESCRIPTION OF MAIN ELEMENTS

1000: GPU-accelerated scheduling system
100: graph preprocessing module
200: scheduling module
300: computation reduction module
400: partition transfer module

What is claimed is:

1. A GPU-accelerated scheduling system comprising:
a CPU including a graph preprocessing module partitioning an input dynamic graph into a plurality of partitions and a scheduling module providing a loading order for the partitioned partitions based on a priority of a predetermined criterion,
wherein the CPU determines the priority based on at least one of whether the partitions are updated, whether the partitions are common, active vertices, and potential active vertices.

2. The GPU-accelerated scheduling system of claim 1, wherein
the scheduling module determines the priority based on an equation below:
$$Val ( {P}_{i} ) = N ( {P}_{i} ) + α \frac{{\sum }_{S , INS} Active ( {P}_{i} )}{\vert S \vert} + β \frac{{\sum }_{S , INS} Potential ( {P}_{i} )}{\vert S \vert} + K$$
where (N(Pᵢ) is a number of snapshots to process Pᵢ when an update occurs, Active(Pᵢ) is a number of active vertices in a partition, Potential(Pᵢ) is a number of potential active vertices in a partition, K indicates whether a partition is updated, and α and β are scaling factors.

3. The GPU-accelerated scheduling system of claim 1, wherein the graph preprocessing module partitions the dynamic graph so that a size of the partitions does not exceed a memory size of the GPU.

4. The GPU-accelerated scheduling system of claim 3, wherein the graph preprocessing module uses a vertex-cut method.

5. The GPU-accelerated scheduling system of claim 1, further comprising:
a partition transfer module transferring the plurality of partitions to the GPU based on the determined loading order.

6. The GPU-accelerated scheduling system of claim 5, wherein the CPU further includes a computation reduction module eliminating unnecessary computations based on a result of a snapshot of the dynamic graph over time before transmitting the partition to the GPU.

7. The GPU-accelerated scheduling system of claim 6, wherein, when insertion and deletion of a specific vertex or edge occurs in the result of the snapshot over time and a result of the snapshot at a specific point in time is the same as a result of a snapshot at a previous point in time before the specific point in time, the computation reduction module omits a computation between the specific point in time and the previous point in time.

8. A scheduling method of a GPU-accelerated scheduling system, the scheduling method comprising:
(a) partitioning, by a CPU, an input dynamic graph into a plurality of partitions; and
(b) determining a loading order of the partitioned partitions based on a priority of a predetermined criterion,
wherein, in (b), the priority is determined based on at least one of whether the partitions are updated, whether the partitions are common, active vertices, and potential active vertices.

9. The scheduling method of claim 8, wherein,
in (b), the priority is determined based on an equation below:
$$Val ( {P}_{i} ) = N ( {P}_{i} ) + α \frac{{\sum }_{S , INS} Active ( {P}_{i} )}{\vert S \vert} + β \frac{{\sum }_{S , INS} Potential ( {P}_{i} )}{\vert S \vert} + K$$
where (N(Pᵢ) is a number of snapshots to process Pᵢ when an update occurs, Active(Pᵢ) is a number of active vertices in a partition, Potential(Pᵢ) is a number of potential active vertices in a partition, K indicates whether a partition is updated, and α and β are scaling factors.

10. The scheduling method of claim 8, wherein, in (a), the dynamic graph is partitioned so that a size of the partitions does not exceed a memory size of the GPU.

11. The scheduling method of claim 10, wherein, in (a), a vertex-cut method is used.

12. The scheduling method of claim 8, further comprising:
(c) transmitting the plurality of partitions to the GPU based on the determined loading order.

13. The scheduling method of claim 12, further comprising:
before (c) and after (b), eliminating unnecessary computations based on a result of a snapshot of the dynamic graph over time before transmitting the partition to the GPU.

14. The scheduling method of claim 13, wherein when insertion and deletion of a specific vertex or edge occurs in the result of the snapshot over time and a result of the snapshot at a specific point in time is the same as a result of a snapshot at a previous point in time before the specific point in time, a computation between the specific point in time and the previous point in time is omitted.
